(19) United States
(12) Patent Application Publication
(10) Pub. No.: US 2009/0280937 A1
(43) Pub. Date: Nov. 12, 2009

(54) Crank power

(76) Inventor: Geoffrey B. Greene, Memphis, TN (US)

Correspondence Address: Geoffrey B Greene, 4066 Clearpool Cir Rd, Memphis, TN, 38118, US

(21) Appl. No.: 12/151,959

(22) Filed: May 10, 2008

(51) Int. Cl. F16H 61/00

(52) U.S. Cl. 474/78

(57) ABSTRACT

An improved crank mechanism for anything with crank arms such as in a bicycle or a wench with a quick release latch between a multiple radius rotary transmission means (oval sprocket, gear, pulley . . . ) and crank arms allowing the timing to be changed on the fly. This will allow a person on a bicycle to sit or stand while keeping the proper timing between the crank and the multiple radius rotary transmission means (oval sprocket, gear, pulley . . . )

### CROSS-REFERENCE TO RELATED APPLICATION

Not applicable

### BACKGROUND

1. Field of Invention

This invention relates to a quick release latch between a multiple ratio rotary transmission means and crank arms.

2. Description of Prior Art

Originally most of the sprockets, pulleys, and gears were round that were attached to crank arms. In most applications the input leverage changed dramatically as the crank arm was spun. Using a bicycle for example a person riding would encounter a dead spot at the top and bottom of each revolution of the crank arm for each leg. Some people attempt to solve this large problem by using lower gears in order to eliminate the dead spot. They did solve the dead spot as they created a spot on the down stroke that was geared way too low to be efficient.

Then an oval sprocket was invented that solved both of these problems as it created a third problem as follows. When a person riding a bicycle stands up their angle of attack changes which interferes with the timing between the oval sprocket and the crank arm.

Then an oval sprocket was invented that could be bolted on in various angles to the crank arm to suit a riders individual style of riding. This change did very little good because when it was adjusted to help the standing angle it automatically hurt the sitting angle. Once it was adjusted in the middle it was little or no better than round sprockets for overall use.

### SUMMARY

In accordance with the present invention an multiple radius rotary transmission means and crank arm with a quick release latch to enable an operator to adjust timing angle while in operation without the need of tools.

### OBJECTS AND ADVANTAGES

Accordingly, besides the advantages of being able to adjust the timing angle while in operation
(a) this invention will keep people from stalling then possibly falling off bicycles.
(b) this invention will open bicycle riding to many more people
(c) this invention makes it easier and faster to wench up sails and other things.
(d) this invention makes it easier and faster to operate so many different machines in many cases people will choose their own power over motors helping the planet.

Further objectives and advantages of my invention will become apparent from a consideration of the drawings and ensuing description.

### DRAWING FIGURES

FIG. 1 is a view of crank arm 21, sproket 23, and latch assembly 24

FIG. 2 is an elevation view showing the two different settings available on this embodiment of my invention.

FIG. 3 is a series of drawings showing some major positions of a crank arm explaining variable input power of a human leg, and the variable output ratios of the sprocket.

### DESCRIPTION AND OPERATION OF THE INVENTION

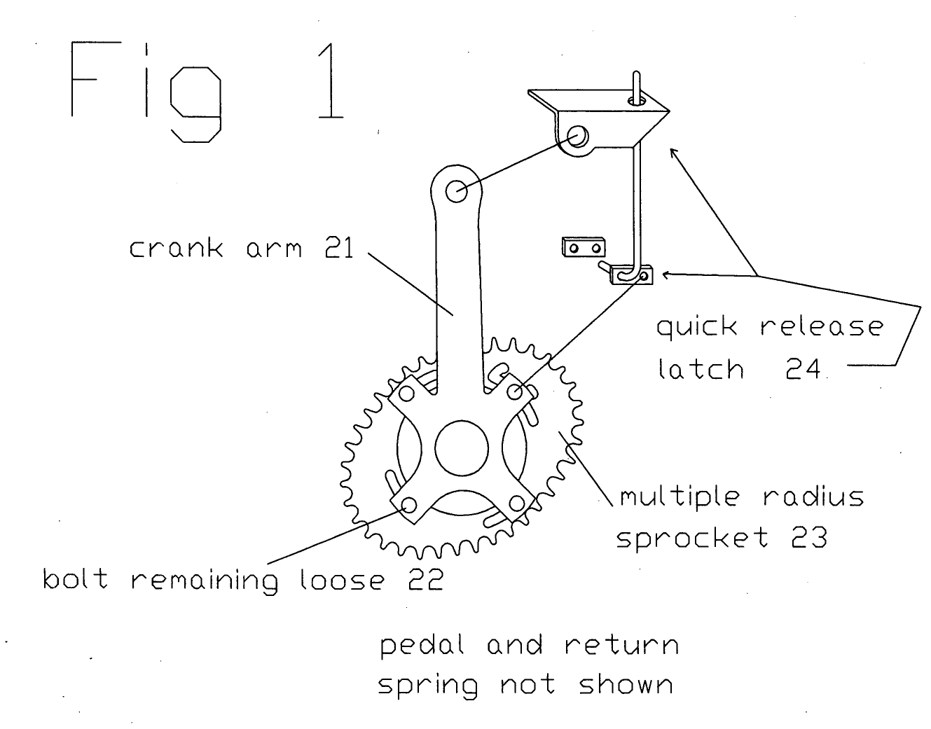

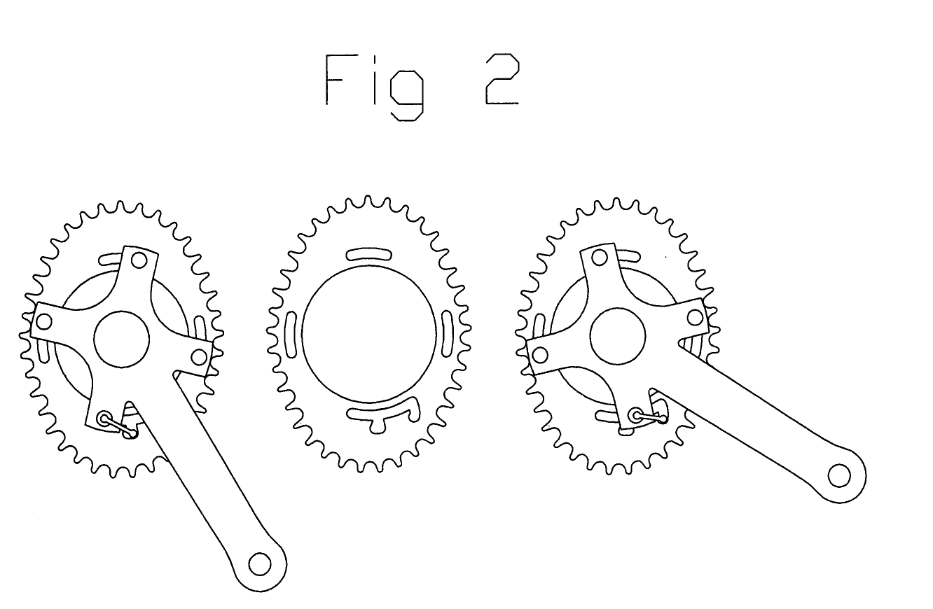

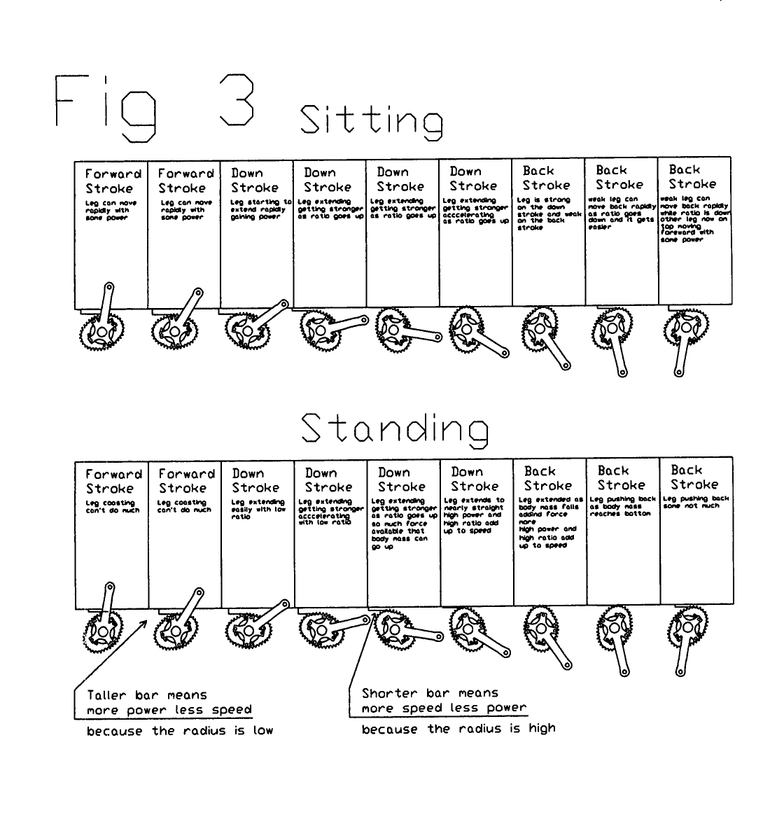

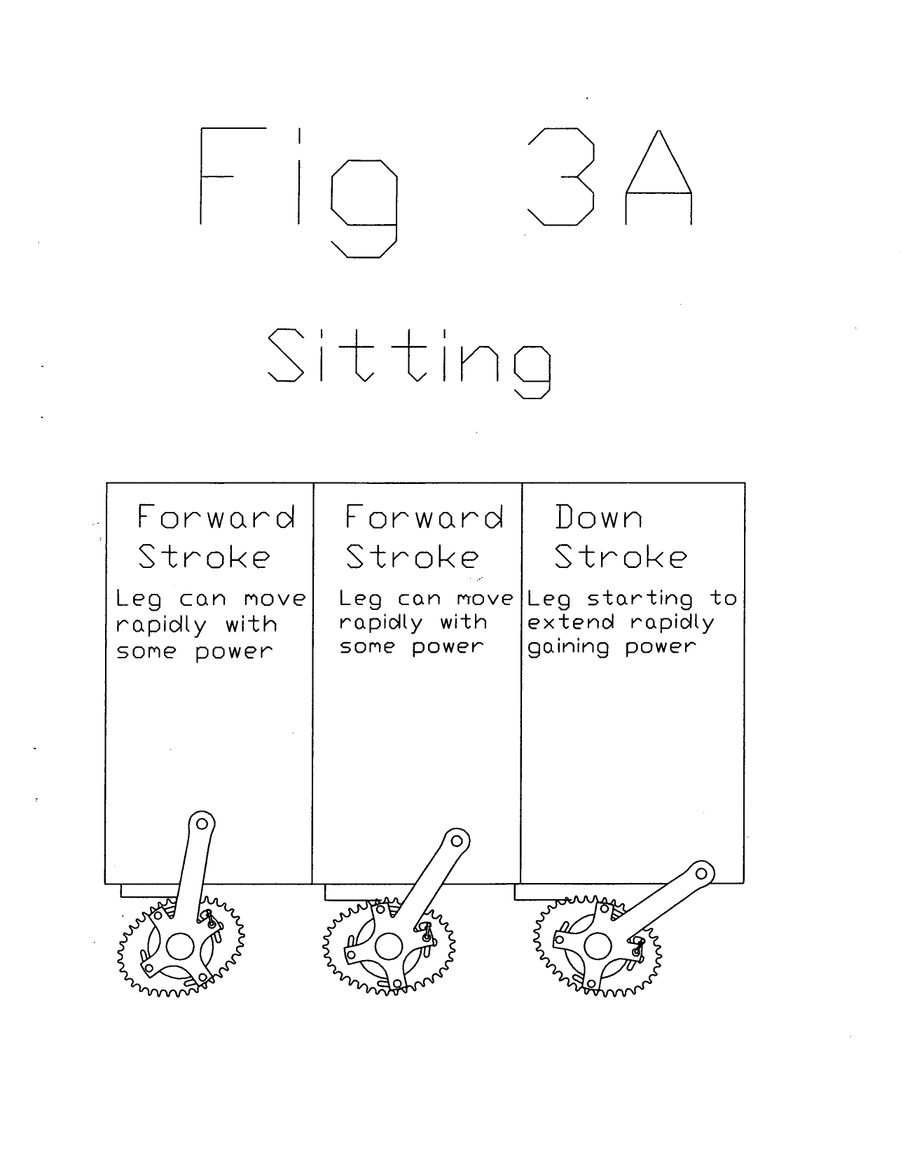

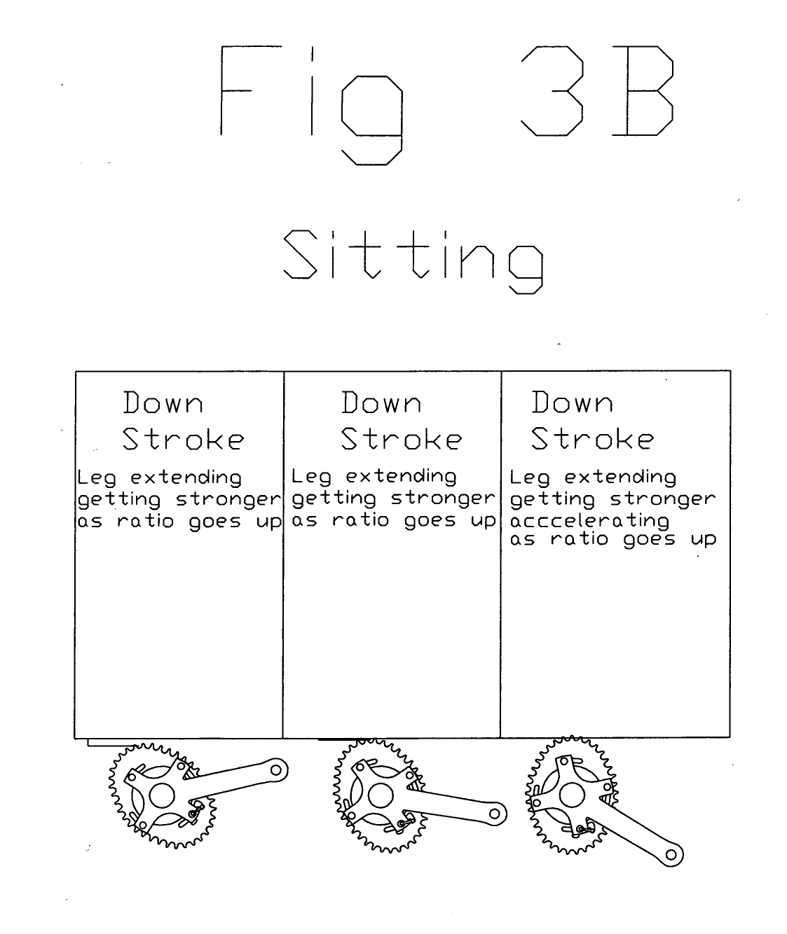

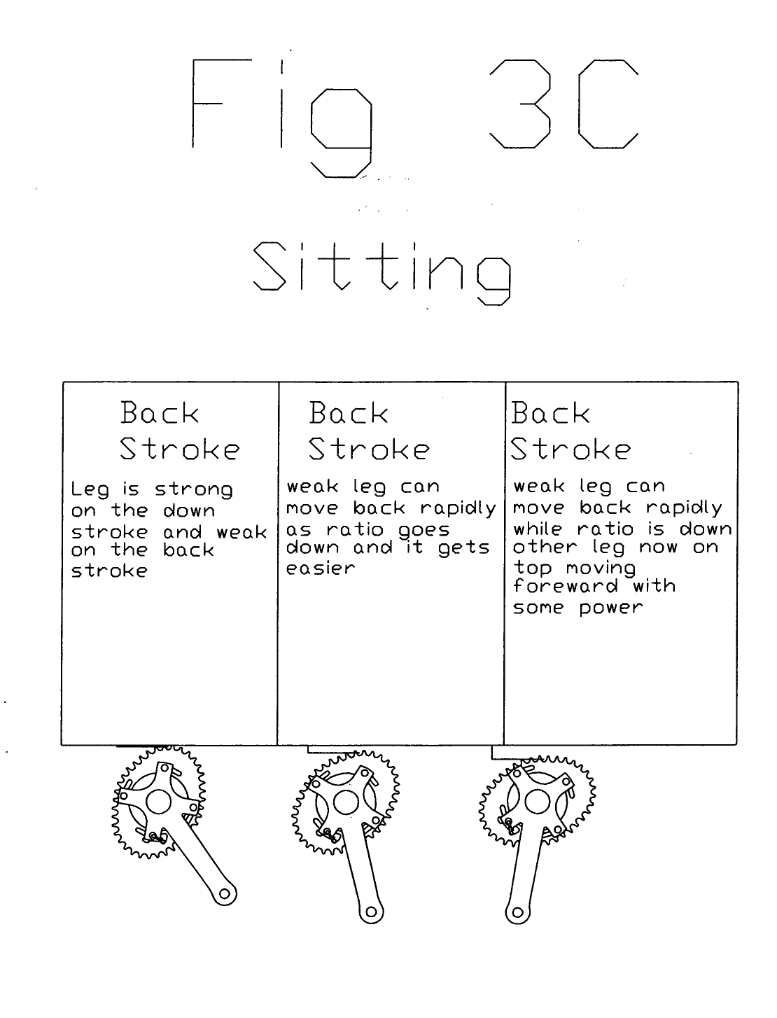

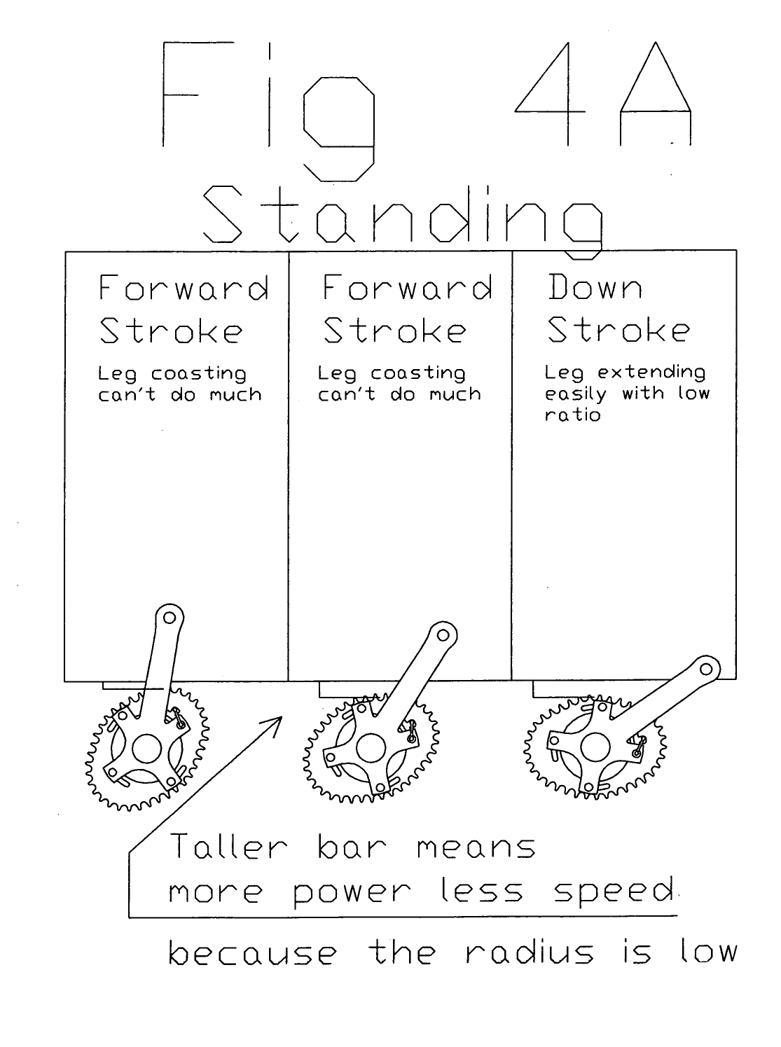

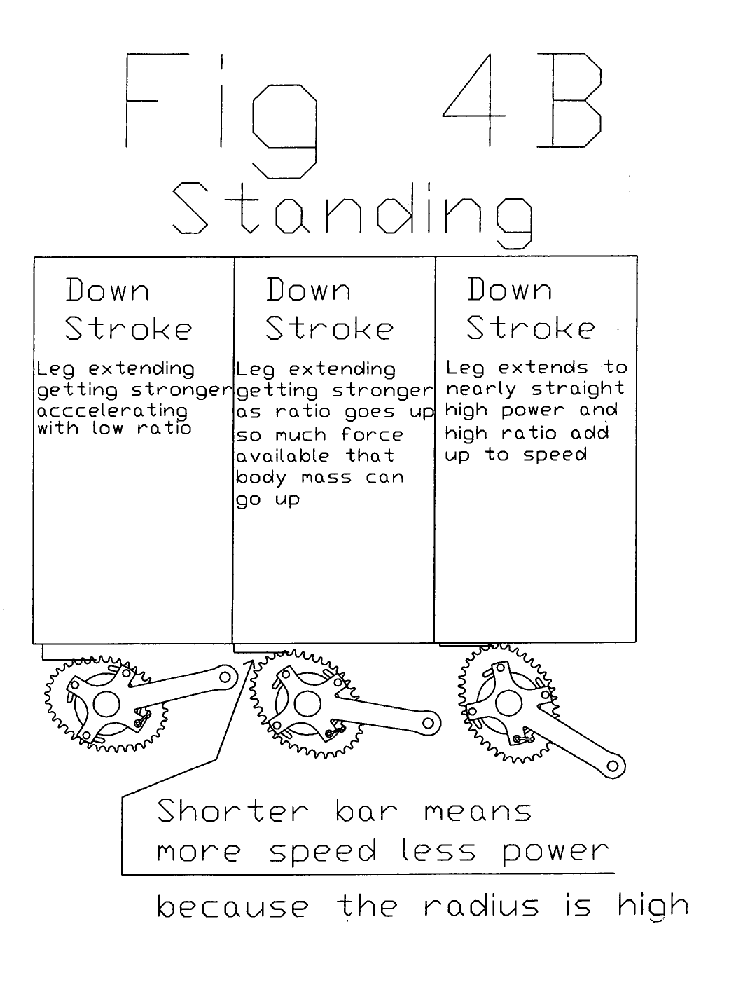

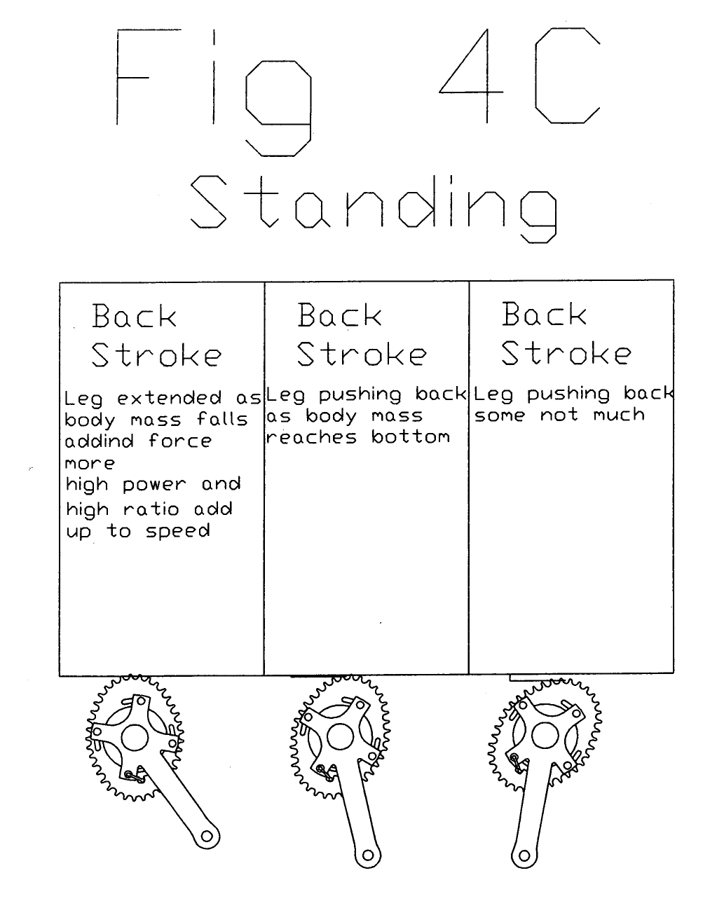

FIG. 1 shows a basic version of my invention. It shows a crank arm 21 attached to a multiple radius sprocket 23 in a manner allowing a quick release latch 24 to advance or retard the crank arm 21 in relationship to the multiple radius sprocket 23. This allows a person to change angles relative to the multiple radius sprocket 23 and get the desired timing between the crank arm 21 and the multiple radius sprocket 23. The advance is achieved pressing down the quick release latch 24 with a human foot and rotating the crank arm 21 foreword.

### CONCLUSIONS RAMIFICATONS AND SCOPE

Accordingly, the reader will see that a person desiring to ride a bicycle can capitalize on my invention in a sitting or standing position. This invention allows more choices after the invention has been installed.

I claim:

1. A multiple radius rotary transmission means and crank comprising:
(a) a quick release latch allowing said multiple radius rotary transmission means to be advanced or retarded in relationship to said crank.
